(19) United States
(12) Patent Application Publication
(10) Pub. No.: US 2025/0069465 A1
(43) Pub. Date: Feb. 27, 2025

(54) VENDING MACHINE FOR MARIJUANA PRODUCTS

(71) Applicant: Noel Abboud, Syracuse, NY (US)

(72) Inventor: Noel Abboud, Syracuse, NY (US)

(21) Appl. No.: 18/236,698

(22) Filed: Aug. 22, 2023

(51) Int. Cl. G07F 17/00; G06Q 20/18; G06Q 20/38

(52) U.S. Cl. CPC G07F 17/0092; G06Q 20/18; G06Q 20/3821

(57) ABSTRACT

A vending machine for dispensing marijuana products includes a cabinet and a dispenser mechanism is mounted in the cabinet. The dispenser mechanism is configured to dispense a selected one of a plurality of products positioned in the cabinet. A processor is operatively coupled to the dispenser mechanism. An identification sensor is mounted on an exterior of the cabinet and is operatively coupled to the processor. The identification sensor is configured to detect indicia of authenticity of an identification card and receive age data from the identification card.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vending machines and more particularly pertains to a new vending machine for dispensing marijuana products.

### (2) Description of Related Art Including Information Disclosed Under 37 CFR 1.97 and 1.98

The prior art describes myriad vending machines. However, the prior art fails to disclose a vending machine for various marijuana products which scans an identification card of a user to verify that they are eligible to purchase the marijuana products.

### BRIEF SUMMARY OF THE INVENTION

An embodiment of the disclosure meets the needs presented above by generally comprising a cabinet and a dispenser mechanism is mounted in the cabinet. The dispenser mechanism is configured to dispense a selected one of a plurality of products positioned in the cabinet. A processor is operatively coupled to the dispenser mechanism. An identification sensor is mounted on an exterior of the cabinet and is operatively coupled to the processor. The identification sensor is configured to detect indicia of authenticity of an identification card and receive age data from the identification card.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vending machine according to an embodiment of the disclosure.

FIG. 2 is a front in-use view of an embodiment of the disclosure.

FIG. 3 is a back view of an embodiment of the disclosure.

FIG. 4 is a side view of an embodiment of the disclosure.

FIG. 5 is a block diagram of an embodiment of the disclosure.

### DETAILED DESCRIPTION OF THE INVENTION

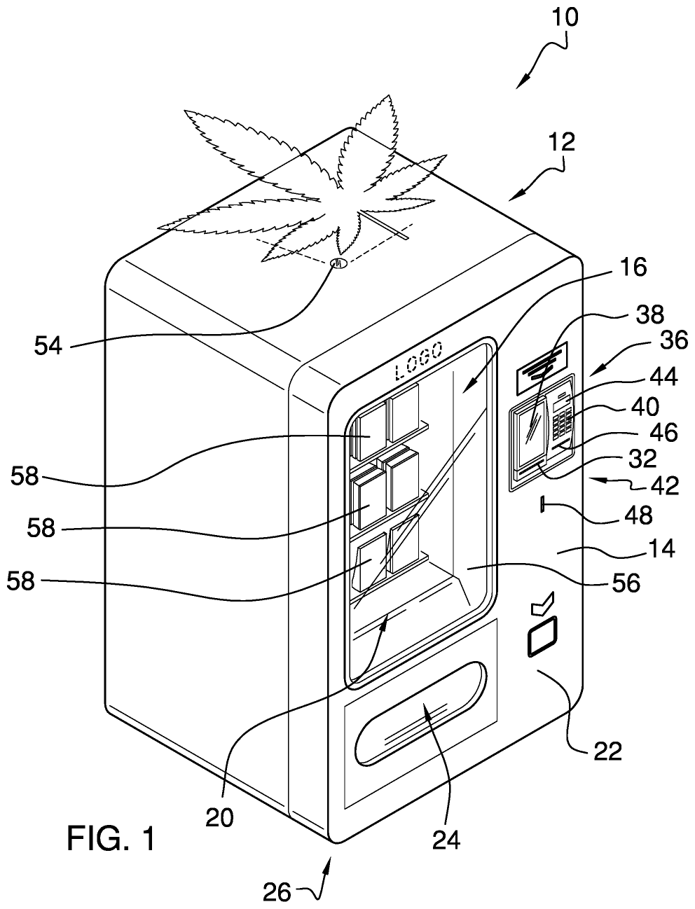

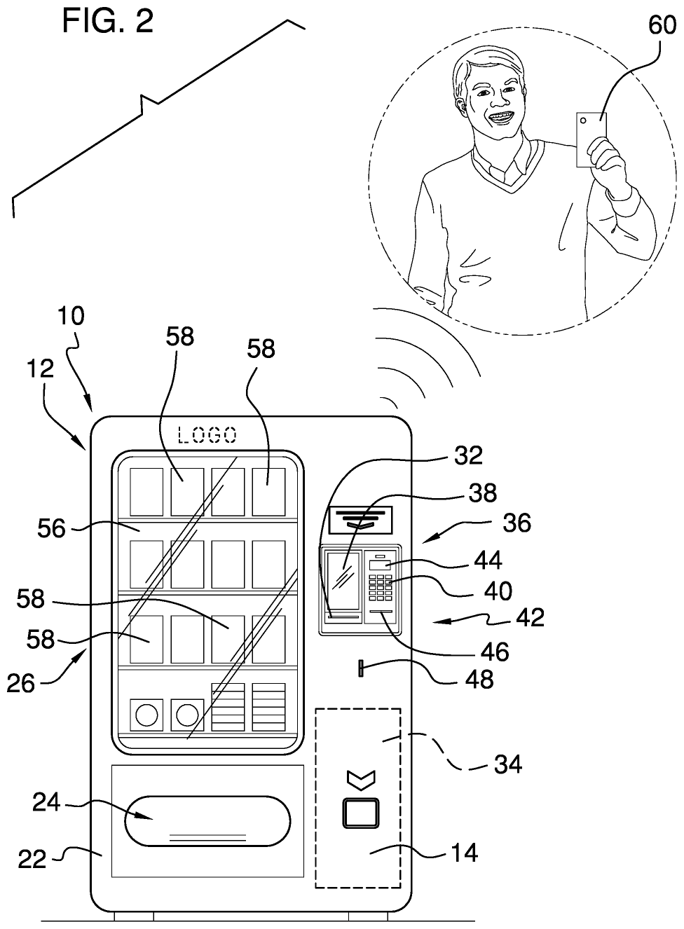

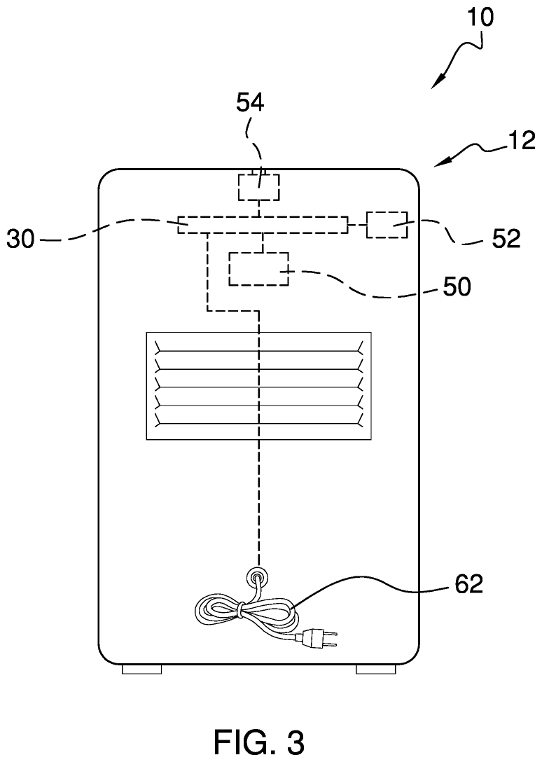

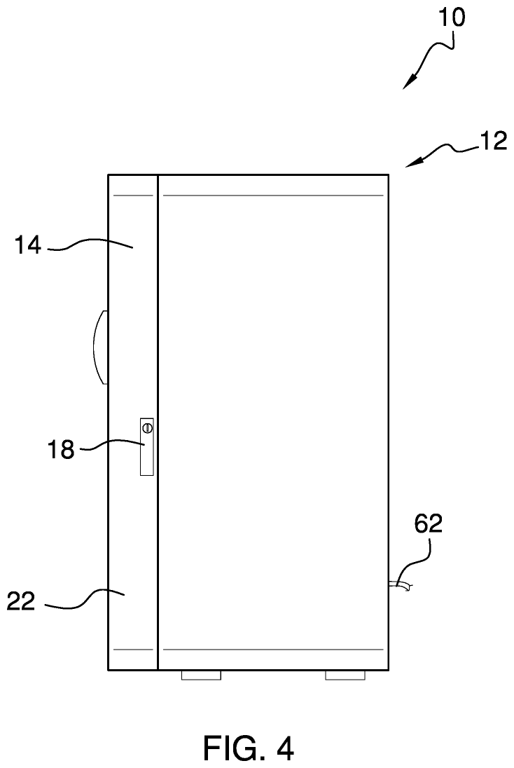

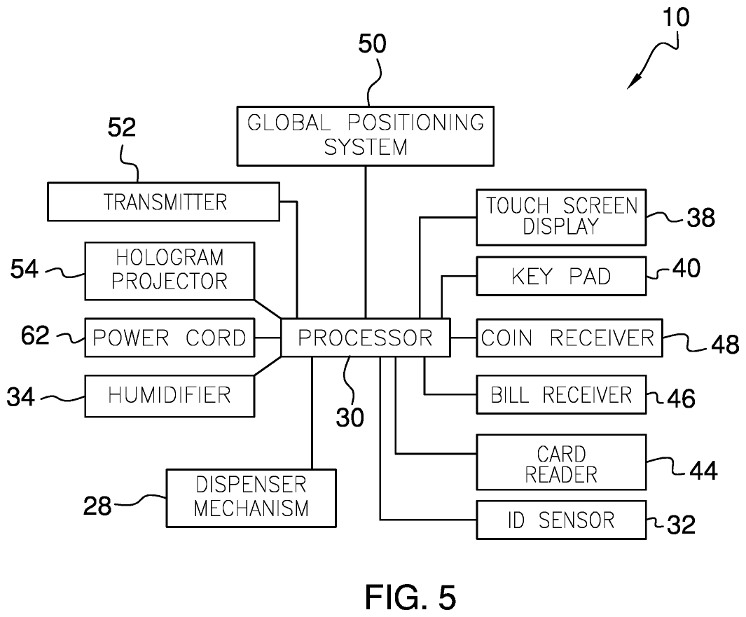

With reference now to the drawings, and in particular to FIGS. 1 through 5 thereof, a new vending machine embodying the principles and concepts of an embodiment of the disclosure and generally designated by the reference numeral 10 will be described.

As best illustrated in FIGS. 1 through 5, the vending machine 10 for dispensing marijuana products generally comprises a cabinet 12 with a door 14 for accessing an interior 16 of the cabinet 12. The door 14 also has a lock 18 for securing the door 14 in a closed position 26 and an access slot 24 in a lower portion 22 of the door 14 for accessing a lower section 20 of the interior 16 of the cabinet 12 through the access slot 24. A dispenser mechanism 28 is mounted in the cabinet 12 and is configured to dispense a selected one of a plurality of products 58 positioned in the cabinet 12. The dispenser mechanism 28 may be any suitable for dispensing the plurality of products 58, such as a helical wire which advances products 58 when rotated about a central axis of the helical wire, a carriage mounted to a guide system which carries the products 58 to a dispensing destination, a robotic arm, or the like. The dispenser mechanism 28 urges the selected product 58 to the lower section 20 of the interior 16 of the cabinet 12 when operated to dispense the selected product 58. A processor 30 is operatively coupled to the dispenser mechanism 28.

An identification sensor 32 is mounted on an exterior of the cabinet 12 and is operatively coupled to the processor 30. The identification sensor 32 is configured to detect indicia of authenticity of an identification card and receive age data from the identification card. The identification sensor 32 may, for example, include optical sensors adapted to detect visual features of the identification card to determine the authenticity of the identification card and obtain the age data. The processor 30 may then compare the age data to programmed age requirements, such as a minimum age, to determine if the owner of the identification card is permitted to purchase the selected product 58. If the age data conforms to the age requirements, the selected product 58 is dispensed.

A humidifier 34 is mounted in the cabinet 12 and is operatively coupled to the processor 30. The humidifier 34 is configured to humidify the interior 16 of the cabinet 12 when activated, thereby preserving desirable characteristics of cannabis stored in the cabinet 12 such as flavor and fragrance. A selection input 36 is mounted on the exterior of the cabinet 12 and is operatively coupled to the processor 30. The selection input 36 is configured to receive selection data for selecting one of the plurality of products 58 for dispensing. The selection input 36 comprises a touchscreen 38 and a keypad 40 but may comprise other suitable selection means such as buttons, knobs, microphones, or the like.

A payment receiver 42 is mounted on the exterior of the cabinet 12. The payment receiver 42 is operatively coupled to the processor 30 and comprises a card reader 44 for receiving payment data from a payment card, a bill receiver 46 for receiving banknotes and detecting indicia of authenticity of the banknotes, and a coin receiver 48 for receiving coinage and detecting indicia of authenticity of the coinage. The indicia of authenticity of the banknotes and the coinage may include visual markers, weight, shape, material composition, and the like.

A global positioning system module 50 is operatively coupled to the processor 30 and is configured to receive location data indicative of a location of the cabinet 12. A transmitter 52 is operatively coupled to the processor 30 and is configured to transmit the location data to a remote electronic device 60 via a communications network. The remote electronic device 60 may be a smart phone, a tablet, a computer, or the like. The communications network may be a cellular network, the Internet, a local area network, a personal area network, or the like.

A holographic projector 54 is mounted on a top 13 of the cabinet 12 and is operatively coupled to the processor 30. The holographic projector 54 is operable to emit a three-dimensional image above the cabinet 12 to indicate the location of the cabinet 12 to passersby. The three-dimensional image may be, for example, a cannabis leaf, a cannabis flower, a logo, a symbol, a string of alphanumeric characters, or the like. A window 56 is mounted in the door 14 and comprises a transparent material such that the interior 16 of the cabinet 12 is viewable from outside the cabinet 12 through the window 56. The transparent material comprises poly(methyl methacrylate) but may comprise other suitable transparent materials. The transparent material may be rigid such that it resists fracture due to impacts. A power cord 62 may be provided so that the processor 30 is couplable to an electrical power supply.

In use, the vending machine 10 is operated to purchase a marijuana product 58, including selecting one of the plurality of products 58, verifying the age of a user of the vending machine 10 via the identification sensor 32, and paying for the selected product 58 via the payment receiver 42. Following these steps, the vending machine 10 dispenses the selected product 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vending machine for dispensing marijuana products, the vending machine comprising:
a cabinet;
a dispenser mechanism being mounted in the cabinet, the dispenser mechanism being configured to dispense a selected one of a plurality of products positioned in the cabinet;
a processor being operatively coupled to the dispenser mechanism; and
an identification sensor being mounted on an exterior of the cabinet, the identification sensor being operatively coupled to the processor, the identification sensor being configured to detect indicia of authenticity of an identification card and receive age data from the identification card.

2. The vending machine of claim 1, wherein the cabinet has a door for accessing an interior of the cabinet, the door having a lock for securing the door in a closed position.

3. The vending machine of claim 2, wherein:
the dispenser mechanism being configured to dispense the selected product to the lower section of the interior of the cabinet; and
the door having an access slot in a lower portion of the door, the access slot facilitating access to a lower section of the interior of the cabinet through the access slot.

4. The vending machine of claim 1, further comprising a humidifier being mounted in the cabinet, the humidifier being operatively coupled to the processor, the humidifier being configured to humidify the interior of the cabinet when activated.

5. The vending machine of claim 1, further comprising a selection input being mounted on the exterior of the cabinet, the selection input being operatively coupled to the processor, the selection input being configured to receive selection data for selecting one of the plurality of products for dispensing.

6. The vending machine of claim 1, further comprising a payment receiver being mounted on the exterior of the cabinet, the payment receiver being operatively coupled to the processor, the payment receiver being configured to receive payment for the selected product.

7. The vending machine of claim 6, wherein the payment receiver comprises a card reader being configured to receive payment data from a payment card.

8. The vending machine of claim 6, wherein the payment receiver comprises a bill receiver being configured to receive banknotes and detect indicia of authenticity of the banknotes.

9. The vending machine of claim 6, wherein the payment receiver comprises a coin receiver being configured to receive coinage and detect indicia of authenticity of the coinage.

10. The vending machine of claim 1, further comprising:
a global positioning system module being operatively coupled to the processor, the global positioning system being configured to receive location data indicative of a location of the cabinet; and
a transmitter being operatively coupled to the processor, the transmitter being configured to transmit the location data to a remote electronic device via a communications network.

11. The vending machine of claim 1, further comprising a holographic projector being mounted on a top of the cabinet, the holographic projector being operatively coupled to the processor, the holographic projector being operable to emit a three-dimensional image above the cabinet.

12. The vending machine of claim 1, further comprising a window being mounted in the door, the window comprising a transparent material such that the interior of the cabinet is viewable from outside the cabinet through the window, the transparent material comprising poly(methyl methacrylate).

13. A vending machine for dispensing marijuana products, the vending machine comprising:
a cabinet, the cabinet having a door for accessing an interior of the cabinet, the door having a lock for securing the door in a closed position, the door having an access slot in a lower portion of the door, the access slot facilitating access to a lower section of the interior of the cabinet through the access slot;
a dispenser mechanism being mounted in the cabinet, the dispenser mechanism being configured to dispense a selected one of a plurality of products positioned in the cabinet, the dispenser mechanism being configured to dispense the selected product to the lower section of the interior of the cabinet;
a processor being operatively coupled to the dispenser mechanism;
an identification sensor being mounted on an exterior of the cabinet, the identification sensor being operatively coupled to the processor, the identification sensor being configured to detect indicia of authenticity of an identification card and receive age data from the identification card;
a humidifier being mounted in the cabinet, the humidifier being operatively coupled to the processor, the humidifier being configured to humidify the interior of the cabinet when activated;
a selection input being mounted on the exterior of the cabinet, the selection input being operatively coupled to the processor, the selection input being configured to receive selection data for selecting one of the plurality of products for dispensing, the selection input comprising a touchscreen and a keypad;
a payment receiver being mounted on the exterior of the cabinet, the payment receiver being operatively coupled to the processor, the payment receiver comprising:
a card reader being configured to receive payment data from a payment card;
a bill receiver being configured to receive banknotes and detect indicia of authenticity of the banknotes; and
a coin receiver being configured to receive coinage and detect indicia of authenticity of the coinage;
a global positioning system module being operatively coupled to the processor, the global positioning system being configured to receive location data indicative of a location of the cabinet;
a transmitter being operatively coupled to the processor, the transmitter being configured to transmit the location data to a remote electronic device via a communications network;
a holographic projector being mounted on a top of the cabinet, the holographic projector being operatively coupled to the processor, the holographic projector being operable to emit a three-dimensional image above the cabinet; and
a window being mounted in the door, the window comprising a transparent material such that the interior of the cabinet is viewable from outside the cabinet through the window, the transparent material comprising poly(methyl methacrylate).
